(19) United States
(12) Patent Application Publication
(10) Pub. No.: US 2002/0071179 A1
(43) Pub. Date: Jun. 13, 2002

(54) Method for manufacturing 3D image display body

(76) Inventors: Kazuo Maeda, Joetsu-City (JP); Yoshihiro Yoshihara, Nagakubiki-gun (JP)

Correspondence Address: Reveo, Inc., 85 Executive Blvd., Elmsford, NY, 10523, US

(21) Appl. No.: 09/874,415

(22) Filed: Jun. 5, 2001

(30) Foreign Application Priority Data
Jul. 30, 1999 (JP) 11-186190
Jun. 12, 2000 (JP) 2000-174888
Mar. 23, 2001 (JP) 2001-75048
Jan. 13, 2001 (KR) 10-2001-0002053

(51) Int. Cl. G02B 27/26; G02B 5/30; G02B 27/28

(52) U.S. Cl. 359/465; 359/483

(57) ABSTRACT

The present invention provides a method for manufacturing a 3D image display body which is used to display 3D images in which right-eye image display parts a and left-eye image display parts b are mixed, this method a phase-difference film is disposed on a transparent support with an adhesive agent interposed. Resist members that are made transparent and need not be removed are then disposed in specified positions on the aforementioned phase-difference film. The phase-difference function of the portions of the phase-difference film on which the aforementioned resist members are not present is eliminated by an appropriate means. A display member is superimposed or bonded on the side of the resist members 4 following drying.

### BACKGROUND OF THE INVENTION

The present invention relates to a method for manufacturing a 3D image display body that is used to display 3D images.

3D image display devices such as that disclosed in disclosed in (for example) U.S. Pat. No. 5,327,285 ('285) by Faris issued on Jul. 5, 1994 and hereby incorporated by reference have been proposed in the past. In this 3D image display device 10, as is shown in FIG. 1, a film 12 in which right-eye image display parts a and left-eye image display parts b are alternately disposed side by side is bonded to the surface of a liquid crystal member 14. When the light emitted by the aforementioned liquid crystal member 14 is controlled so that a specified image is displayed, a right-eye image is displayed from the right-eye image display parts a, and a left-eye image is displayed from the left-eye image display parts b. Furthermore, since the device is constructed so that the direction of vibration of the polarized light constituting the right-eye image from the right-eye image display parts a has an angle of 90° relative to the direction of vibration of the polarized light constituting the left-eye image from the left-eye image display parts b (i.e., since the device is constructed so that (for example) the x component of the right-eye image consisting of two components x and y has a phase difference of 180° (π) with respect to the x component of the left-eye image which similarly consists of two components x and y), the observer can experience the sensation of observing a three-dimensional image when the aforementioned image is viewed using polarizing eyeglasses consisting of a polarizer-equipped right-eye lens that transmits only the right-eye image and a polarizer-equipped left-eye lens that transmits only the left-eye image.

As has been disclosed in the past in FIG. 2 of the '285 patent, the aforementioned film 12 in which right-eye image display parts a and left-eye image display parts b are alternately disposed side by side is manufactured by a method in which a polarizing film formed by laminating a TAC film (triacetylcellulose film) and an iodine-treated drawn PVA film (polyvinyl alcohol film) is coated with a photoresist, and specified portions of this coated film are exposed, after which these portions are treated with a potassium hydroxide solution, so that the property that a drawn PVA film has of being able to rotate the direction of vibration of light in a specified wavelength region with the linearly polarized state of the light maintained “as is” (phase-difference function) is eliminated, etc. However, since this method is a method in which the photoresist is removed by an alkali treatment following the above-mentioned treatment with a potassium hydroxide solution, the drawn PVA film may be damaged by this alkali treatment, so that the functions of the right-eye image display parts a and left-eye image display parts b deteriorate.

The present invention provides a method for manufacturing a 3D image display body in which right-eye image display parts a and left-eye image display parts b are mixed, and which has a good function.

### SUMMARY OF THE INVENTION

The object of the present invention is to allow the easy production of a film which has right-eye image display parts a and left-eye image display parts b, and which is superior in terms of optical characteristics.

### BRIEF DESCRIPTION OF THE DRAWINGS

The present invention will be described below with reference to the attached figures wherein:

FIG. 1 is an explanatory diagram of a conventional 3D image display device:.

FIG. 2 is a structural explanatory diagram of a first embodiment of the present invention; and

FIG. 3 is a structural explanatory diagram of a second embodiment of the present invention.

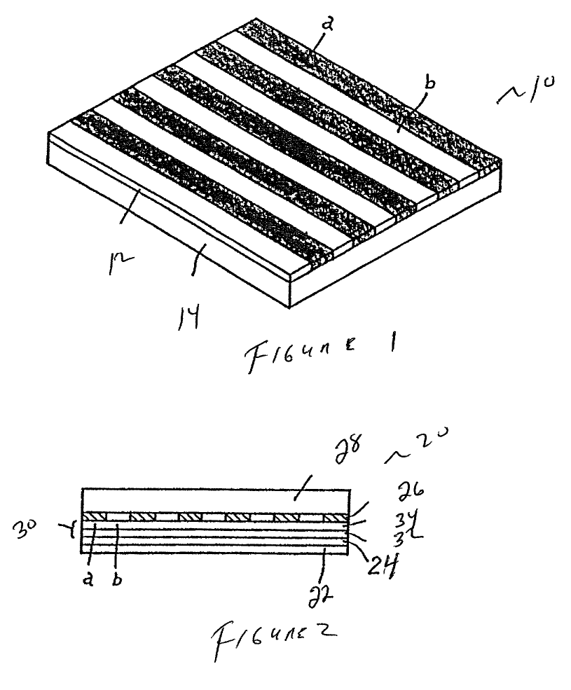

### DETAILED DESCRIPTION OF THE INVENTION

The present invention relates to a method for manufacturing a 3D image display body which is used to display 3D images in which right-eye image display parts a and left-eye image display parts b are mixed. The 3D image display body 20 manufacturing method having a phase-difference film 30 that is disposed on a transparent support 22 with an adhesive agent 24 interposed. Resist members 24 which are made transparent and need not be removed are then disposed in specified positions on the aforementioned phase-difference film. The phase-difference function of the portions of the phase-difference film 30 on which the aforementioned resist members 26 are not present is eliminated by an appropriate means. A display member 28 is superimposed or bonded on the side of the resist members 26 following drying.

Furthermore, the present invention also relates to a method for manufacturing a 3D image display body which is used to display 3D images in which right-eye image display parts a and left-eye image display parts b are mixed, wherein a laminated phase-difference film 30 is formed by laminating a TAC film 32 or CAB film, etc., that does not possess birefringence and a drawn PVA film 34 that has a phase-difference function is disposed on a transparent support 22 with an adhesive agent 24 interposed so that the TAC film 32, etc., is located on the side of the adhesive agent 24. Resist members 26 that are made transparent and need not be removed are then disposed in specified positions on the aforementioned drawn PVA film 34. The phase-difference function of the portions of the drawn PVA film 34 on which the aforementioned resist members 26 are not present is eliminated by an appropriate means. A display member 28 is superimposed or bonded on the side of the resist members 26 following drying.

Furthermore, the present invention also relates to a 3D image display body 20 manufacturing method which additionally includes the resist members 26 that are linear bodies that are disposed at specified intervals on the drawn PVA film 34 from one side of the drawn PVA film 34 to the other side.

Furthermore, the present invention also relates to a 3D image display body 20 manufacturing method which also includes the resist members 26 consisting of a resist ink that is applied to the surface of the drawn PVA film 34 by screen printing.

Furthermore, the present invention also relates to a 3D image display body 40 manufacturing method which includes a protective member 42 that does not possess birefringence disposed on the side of the resist members 26 following drying, and a display member 26 that is then superimposed on or bonded to this protective member 42.

When resist members 26 that are made transparent and need not be removed are disposed in specified positions on a phase-difference film 30, an appropriate means is then applied to the portions of the phase-difference film where the aforementioned resist members 26 are not present, so that the property that the aforementioned phase-difference film 30 has of being able to rotate the direction of vibration of light in a specified wavelength region with the linearly polarized state of the light maintained “as is” (i.e., the phase-difference function) is eliminated. A film is obtained in which the phase of the transmitted light is shifted by 180° between the portions where resist members 26 are present and the portions where no resist members 26 are present. In this case, since the resist members 26 are not removed by means of a chemical agent, etc., damage to the phase-difference film can be suppressed to a minimum.

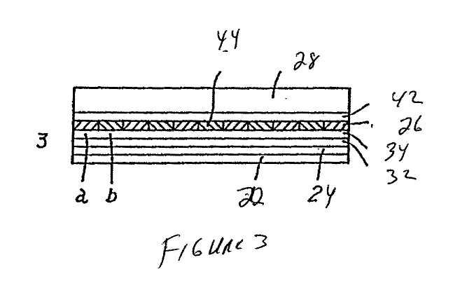

FIG. 2 illustrates a first embodiment of the present invention, which will be described below in detail.

A laminated phase-difference film 30 (½-wave plate) formed by laminating a TAC film 32 (thickness: 126 μm) and a uniaxially drawn PVA film 34 (thickness: 38 μm) that has a phase-difference function is disposed on the surface of a transparent support 22 (e.g., a glass plate or cellulose acetate butyrate (CAB) plate, etc., with a thickness of approximately 2 mm) with an adhesive agent 24 (e.g., an ultraviolet-curable resin) interposed, and the ultraviolet-curable resin is cured by means of ultraviolet light. Furthermore, a glass plate that does not possess birefringence is most desirable as the support 22. Moreover, besides a film formed by laminating a TAC film 32 on a drawn PVA film 34, a film formed by laminating a CAB film on such a drawn PVA film 34, etc., may also be used as the laminated phase-difference film 30. In short, any laminated film formed by laminating a film that is substantially free of birefringence on a drawn PVA film 34 may be used as the laminated phase-difference film 30.

Next, a transparent urethane-type resist ink (HIPET 9300 Medium manufactured by Jujo Chemical K.K.) which has a high water resistance is applied to the uniaxially drawn PVA film 34 as resist members 26 in specified positions. In this case, the resist ink is applied in the form of linear bodies with a width of 160 μm to the surface of the drawn PVA film 34 from one side of the film to the other. These linear bodies are disposed side by side at a pitch of 160 μm. Furthermore, it is not necessary that the resist ink have a uniform width and uniform pitch as described above. Moreover, the ink need not be applied in the form of linear bodies. It is also possible, for example, to dispose square bodies (as seen in a plan view) in a staggered arrangement.

The aforementioned photoresist in the '285 patent need merely be able to withstand exposure and treatment with a potassium hydroxide solution. No consideration is given to reliability in the case of long-term use with the photoresist left “as is” (for example, coloring and chipping may occur as a result of long-term use). The photoresist is subsequently removed by an alkali etching or a water flushing treatment. There is a danger that the drawn PVA film 34 may be damaged by such alkali etching and that the characteristics of the portions where the resist ink is present and portions treated with hot water as described below may be altered.

In this regard, the present embodiment uses a transparent urethane-type resist ink as the above-mentioned resist ink. This ink is superior in terms of durability and therefore need not be removed. Accordingly, the above-mentioned problems do not arise. Furthermore, the problem of degeneration of the above-mentioned drawn PVA film 34 is also solved, so that the sharpness of the images are also be maintained.

After the resist ink has been applied, this assembly is immersed for approximately 30 seconds in hot water at a temperature of 80° C. (of course, the peripheral surfaces are subjected to an appropriate waterproofing treatment), so that the orientation of the molecules in the drawn PVA film 34 are destroyed by allowing water to permeate into the portions where no resist ink is present. This eliminates the aforementioned phase-difference function that was present in the state prior to drawing. The phase-difference function is intrinsically possessed by the drawn PVA film 34. In this way, the portions where the resist ink is present are converted into (for example) right-eye image display parts a, and the portions where no resist ink is present are converted into left-eye image display parts b. As a result of various experiments, it has been confirmed that the properties of the above-mentioned drawn PVA film 34 are similarly lost if the film is immersed for 5 seconds to 10 minutes in hot water at a temperature of 80° C. to 100° C.

Next, with the resist ink left “as is,” a display member 28 which has a liquid crystal disposed inside is superimposed by means of a magnet, etc., or bonded by means of an appropriate adhesive agent, thus producing a 3D image display body 20.

The positions where the resist ink is applied, i.e., the positions of the right-eye image display parts a and left-eye image display parts b, are set so that they coincide with the pitch of the liquid crystal cells of the display member 28 that is bonded.

A film in which right-eye image display parts a and left-eye image display parts b are disposed side by side and which is superior in terms of optical characteristics can easily be obtained by means of the above manufacturing method. Accordingly, a 3D image display body that has good performance can also easily be obtained.

Furthermore, if the respective members are provided in the form of rolls in the above-mentioned manufacturing process, continuous manufacture is possible, so that the productivity of the 3D image display body is improved even further.

When the image from the 3D image display body manufactured as described above is viewed through polarizing eyeglasses consisting of a polarizer-equipped right-eye lens that transmits only the right-eye image from the right-eye image display parts a and a polarizer-equipped left-eye lens that transmits only the left-eye image from the left-eye image display parts b (i.e., an image that is composed of light that vibrates in a direction that is 90° perpendicular to the direction of vibration of the light composing the right-eye image), the observer can experience the sensation of viewing the above-mentioned image as a three-dimensional image.

FIG. 3 illustrates a second embodiment of the present invention, which will be described below. In this second embodiment, a UV resin, PVA-type adhesive agent or acrylic-type tacky adhesive material, etc., is applied to the surface of the drawn PVA film 34 as appropriate members 44 in the spaces between the resist ink. Furthermore, a TAC sheet, glass plate or CAB (cellulose acetate butyrate) sheet is laminated as a protective member 42, and a display member 28 is laminated on the surface of this protective member 42. The remainder of this embodiment is similar to the first embodiment shown in FIG. 2.

Moreover, the appropriate members 44 and protective member 42 may consist of any appropriate resin coating that does not possess birefringence, so that this coating causes no change in phase.

It is understood that method of manufacturing a 3D image display body may be modified in a variety of ways which will become readily apparent to those skilled in the art of having the benefit of the teachings disclosed herein. All such modifications and variations of the illustrative embodiments thereof shall be deemed to be within the scope and spirit of the present invention as defined by the claims to the invention appended hereto.

What is claimed is

1. A method for manufacturing a 3D image display body which is used to display 3D images in which right-eye image display parts and left-eye image display parts are mixed, said 3D image display body manufacturing comprising:
disposing a phase-difference film on a transparent support with an adhesive agent interposed;
disposing resist members which are made transparent and need not be removed in specified positions on the aforementioned phase-difference film;
eliminating the phase-difference function of the portions of the phase-difference film on which the aforementioned resist members are not present by an appropriate means, and
superimposing or bonding a display member on the side of the resist members following drying.

2. A method for manufacturing a 3D image display body which is used to display 3D images in which right-eye image display parts and left-eye image display parts are mixed, said 3D image display body manufacturing method comprising:
a laminated phase-difference film formed by laminating a TAC film or CAB film, etc., that does not possess birefringence and a drawn PVA film that has a phase-difference function is disposed on a transparent support with an adhesive agent interposed so that the TAC film, etc., is located on the side of the adhesive agent:
resist members which are made transparent and need not be removed are then disposed in specified positions on the aforementioned drawn PVA film,
the phase-difference function of the portions of the drawn PVA film on which the aforementioned resist members are not present is eliminated by an appropriate means, and
a display member is superimposed or bonded on the side of the resist members following drying.

3. The manufacturing method of claim 2 wherein the resist members are linear bodies that are disposed at specified intervals on the drawn PVA film from one side of the drawn PVA film to the other.

4 The manufacturing method of claim 2 wherein the resist members comprise of a resist ink that is applied to the surface of the drawn PVA film by screen printing.

5 The manufacturing method of claim 3 wherein the resist members comprise of a resist ink that is applied to the surface of the drawn PVA film by screen printing.

6 The manufacturing method of any one claim 2 wherein a protective member that does not possess birefringence is disposed on the side of the resist members following drying, and a display member is then superimposed on or bonded to this protective member.

7. The manufacturing method of any one claim 3 wherein a protective member that does not possess birefringence is disposed on the side of the resist members following drying, and a display member is then superimposed on or bonded to this protective member.

8 The manufacturing method of any one claim 4 wherein a protective member that does not possess birefringence is disposed on the side of the resist members following drying, and a display member is then superimposed on or bonded to this protective member.

9. The manufacturing method of any one claim 5 wherein a protective member that does not possess birefringence is disposed on the side of the resist members following drying, and a display member is then superimposed on or bonded to this protective member.
